(19) United States
(12) Patent Application Publication
(10) Pub. No.: US 2006/0286915 A1
(43) Pub. Date: Dec. 21, 2006

(54) Coin conveying apparatus

(76) Inventor: Timothy William Hill, Shrewsbury (GB)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/442,753

(22) Filed: May 30, 2006

(30) Foreign Application Priority Data
Jun. 3, 2005 (GB) 0511299.0

(51) Int. Cl. G07D 1/00

(52) U.S. Cl. 453/56

(57) ABSTRACT

A coin conveying apparatus has a belt provided with a perforated coin support surface, and with a rack of belt teeth, for driving the belt by a toothed drive member. Coins are held to the belt by vacuum suction forces. An elongate vacuum manifold extends along a portion of the path of the belt, and coins that are in face contact with the coin support surface of the belt over said path portion are subject to suction forces to hold those coins against the belt, whereby the coins are conveyed by the belt along said portion of the belt path. Vacuum distribution means is provided for varying the suction forces applied to the coins according to the position of the coins along the said belt path portion, whereby the suction forces are enhanced at the upstream end of the belt path portion, to assist in the initial gripping of the coins to the belt when the coins first encounter the belt.

### CROSS-REFERENCE TO RELATED APPLICATION

This application claims the benefit of British patent application no.0511299.0, filed on Jun. 3, 2005.

### INCORPORATION BY REFERENCE

The specification and drawings of British patent application no. 0511299.0, filed on Jun. 3, 2005, are incorporated herein in their entirety, by this reference.

### FIELD OF THE INVENTION

This invention relates to coin conveying apparatus.

The term ‘coin’ is used herein to include bogus coins, coin blanks, washers and other coin-like items.

### BACKGROUND OF THE INVENTION

In coin conveying apparatus for handling large quantities of coins in a relatively short time it can be desirable to be able to feed coins in single file in a controlled manner to enable the coins to be subjected in sequence to an inspection and/or sorting procedure.

Various types of coin feeding devices have been developed for this purpose. One type of coin feeder comprises a narrow coin driving belt, the belt being arranged to extend along a table of greater width than the belt, and such that coins are trapped between the belt and the table and are driven along the table by the belt. An example of such a coin feeding device is shown in our earlier patent specification no. EP 0269690B.

In that arrangement an encoder is associated with the belt drive so that the position of each coin can be calculated from the encoder output as the coin proceeds along the table. This means that any procedure that is conducted on the coin towards the downstream end of the path, such as action to deflect the coin, can be timed accordingly. Although that earlier arrangement works relatively well, the accuracy in maintaining the positions of the coins relative to one another as the coins travel along the table is limited in general by the frictional properties of the belt and coins.

Also, since the belt overlies a portion of a coin being driven by the belt, it is not possible to conduct an optical inspection of the full face of a coin, at least on that side masked in part by the belt, during feeding by the belt. In addition, aluminium blanks and coins can be damaged through being slid along the table surface.

The present invention is concerned with the use of vacuum suction means to hold coins against a belt.

The use of vacuum suction means as an auxiliary coin-holding means only was mentioned in patent specification no. WO 94/04997 which discloses a coin transporting apparatus in which a coin-transporting belt is provided with a series of equally spaced-apart mechanical locating means to abut with the rear edges of coins to drive them along the belt path. The coins are accordingly trapped by the belt only in the positions that are defined by the projecting locating means.

### SUMMARY OF THE INVENTION

According to the invention a coin conveying apparatus comprises a belt provided with a perforated coin support surface, and with a rack of belt teeth, belt drive means comprising a toothed drive member meshed with the belt teeth for driving the belt, the belt being substantially devoid of coin driving projections on said coin support surface that are adapted to engage with the rear edges of coins to carry the coins with the belt, an elongate vacuum manifold extending along a portion of the path of the belt, a vacuum connection to the manifold, the arrangement being such that when a vacuum source is connected to the vacuum connection, coins that are in face contact with the coin support surface of the belt over said path portion are subject to suction forces to hold those coins against the belt, whereby the coins are conveyed by the belt along said portion of the belt path, and vacuum distribution means for varying the suction forces applied to the coins according to the position of the coins along said belt path portion, whereby the suction forces are enhanced at the upstream end of the belt path portion to assist in the initial gripping of the coins to the belt when the coins first encounter the belt.

The belt in cross-section is preferably provided with the rack of teeth along at least one lateral edge of the belt, and preferably with respective racks of teeth along both lateral edges, and a laterally intermediate part of the belt constitutes the coin support surface provided with the perforations. The belt cross-section is preferably of shallow channel section, said teeth being formed in or on one or both side walls of the channel section, the base of the channel section providing said coin support surface.

A particular advantage of the inventive conveying apparatus is that the relative positions of the coins being conveyed by the belt can be more accurately maintained during passage of the coins from the in-feed end of the belt path to the out-feed end, by providing a distribution of the belt perforations. This permits of more precise co-ordination of actions on the coins, which may be one or more measurements or/and mechanical actions. Also, it becomes possible in general to have the coins closer together on the belt than would be possible with WO 94/04997.

Said portion of the belt path subject to vacuum may be associated with a belt supporting table, preferably extending from closely adjacent to one conveyor roller at the upstream end of the belt to a second conveyor roller at the downstream end of the belt.

The belt supporting table preferably carries a support plate received substantially in the channel of the belt so as to assist in guiding the belt.

The supporting table preferably forms the outer face of the vacuum manifold, the table being formed with at least one elongate slot for subjecting a lengthwise strip of the overlying belt to vacuum.

The use of a slot is advantageous in maintaining a vacuum force on the coins as they are conveyed by the belt.

Preferably the supporting table is formed with two longitudinally-extending slots, one extending for substantially the full length of said plate, and the other extending from the upstream end of the plate for a limited distance towards the downstream end of the plate.

This arrangement of one short and one long slot constitutes vacuum distribution means for providing more intense vacuum forces on the coins as they are first engaged by the belt at the upstream end, in order to provide said assistance to initially gripping the coins and binding them to the travelling belt.

Alternatively, a vacuum distribution means could comprise a series of vacuum supply ports with progressively reduced dimensions as one proceeds along the belt path from the upstream end of the belt path.

A further embodiment of the vacuum distribution means is a series of vacuum supply ports in said supporting table, the supply ports being provided with countersinks of differing dimensions in that end of the port facing the coins.

Other objects and aspects of the present invention will become apparent to those skilled in the art after reading this entire specification. It should be understood that both the foregoing general description and the following detailed description are exemplary and explanatory only and are not restrictive of the invention as claimed. A coin conveying assembly in accordance with the invention will now be described, by way of example only, with reference to the accompanying drawings.

### BRIEF DESCRIPTION OF THE DRAWINGS

In the drawings,

FIG. 1 is a plan view of the assembly in which, for convenience, the perforations in the belt are not shown for the full run of the belt, and the belt drive motor is omitted,

FIG. 2 is a side elevation, looking in the direction of the arrow A in FIG. 1,

FIG. 3 is an enlarged cross-section taken on the line 3-3 of FIGS. 1 and 2,

FIG. 4 is an underplan view,

FIG. 5 is a perspective view of the assembly, without the drive motor,

FIG. 6 is an exploded perspective view, and

FIG. 7 is an enlarged transverse cross-section of the belt.

### DESCRIPTION OF THE PREFERRED EMBODIMENT

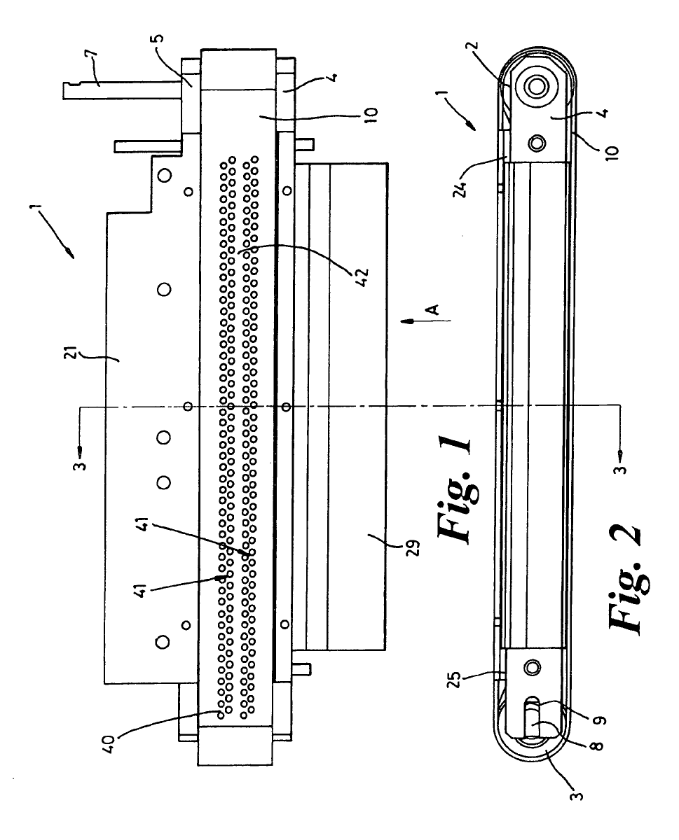

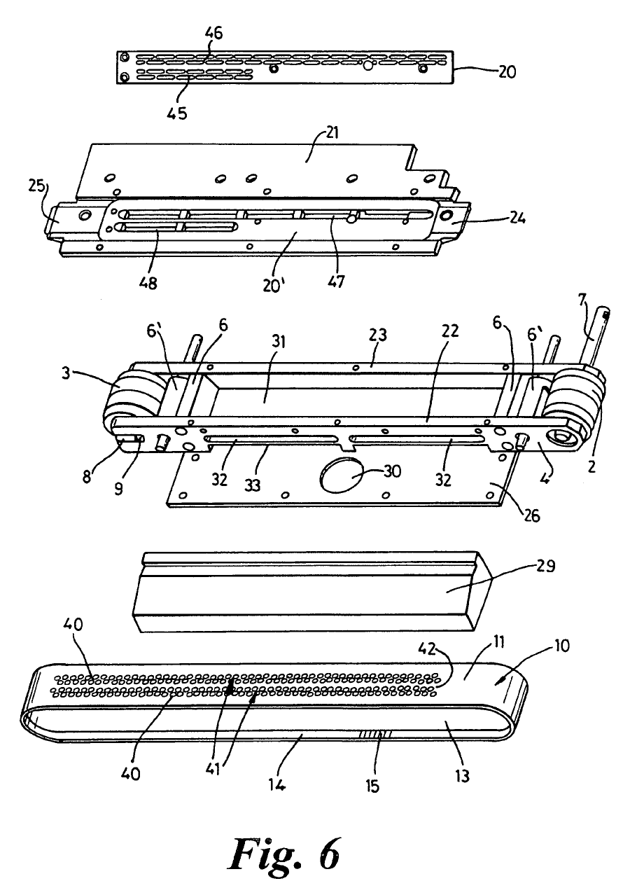

With reference to FIGS. 1 and 2, the coin conveying assembly 1 comprises a belt 10 which extends around a crowned drive roller 2 at the downstream end of the assembly and a crowned idler roller 3 at the upstream end. The drive roller 2 is journalled in parallel side-frames 4, 5 that are spaced apart by transverse walls 6 and by tubular spacers 6′, FIG. 6, and carries a drive shaft 7 connected, in use, to a suitable drive motor.

The idler roller 3 has its opposite ends journalled in respective slide blocks 8 that are slideable in slots 9 extending longitudinally of the respective frames 4, 5.

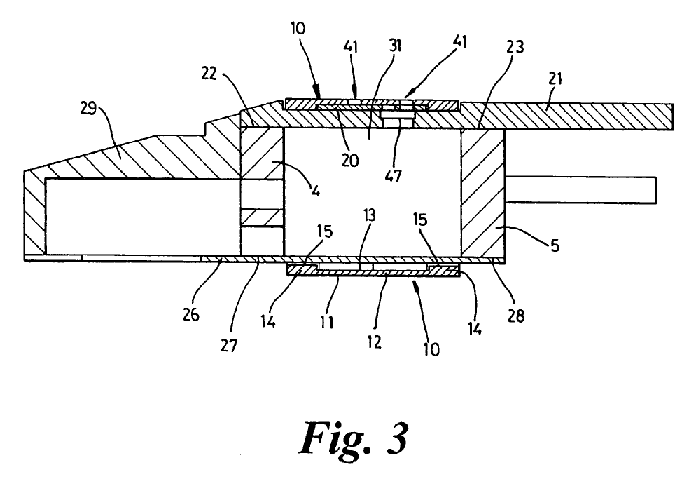

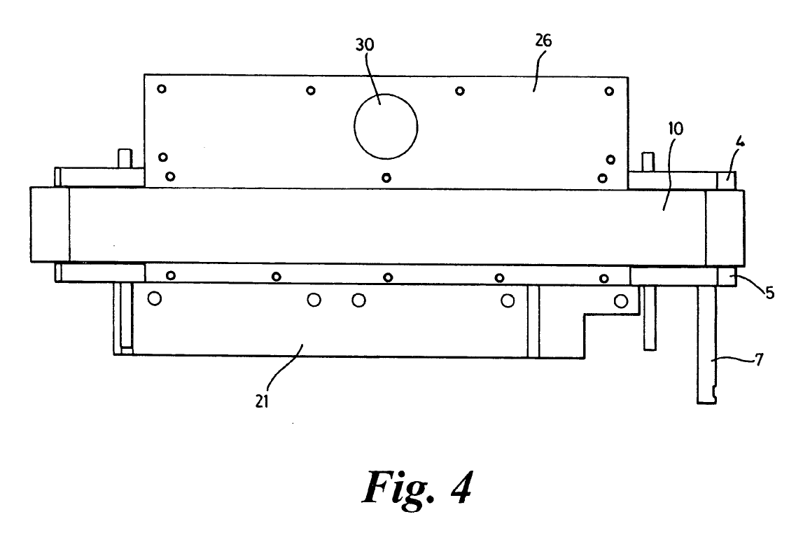

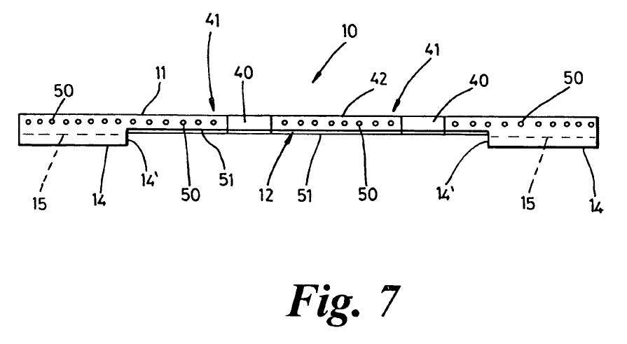

A screw adjustment mechanism, not shown, is arranged to act on the blocks 8 in order to urge the roller 3 away from roller 2 to tension the belt. The belt is conveniently an industrial timing belt that has been modified for this purpose. For example a timing belt of type OPTIBELT OME 64 804 3M-A can be employed. The belt as supplied has teeth extending across the entire width of the inner face of the belt, the outer face 11 being plain. The belt, as shown in FIG. 7, contains a layer of reinforcement 50 which is positioned in the belt towards the outer face 11 of the belt. We grind away the teeth in a broad central region of the belt, so as to produce a belt cross-section of channel shape. The base 12 of the channel thus has the original, smooth outer face 11, and the smoothly-ground inner face 13, the base 12 being flanked by upstanding side walls 14, FIG. 3 that are provided with a respective rack of teeth 15, constituted by the opposite lateral ends of the original full width teeth. We coat the inner face 13 of the base of the belt with a layer 51 of PTFE to assist sliding of the belt over an elongate support plate 20, shown in the upper part of FIG. 6. The provision of the PTFE layer 51 on the belt rather than on the support plate 20 means that replacement of the belt will result in replacement of the PTFE layer.

Support plate 20 is carried by a belt supporting table in the form of an upper closure plate 21 that is secured by screws, not shown, to the upper edges 22, 23 respectively of frames 4 and 5. Closure plate 21 is provided with a recess 20′ to receive the lower part of support plate 20. The plate 21 is provided with infeed and outfeed platforms 25, 24 respectively to assist in supporting the upper run of the belt in the regions close to the rollers 2 and 3 respectively.

A lower plate 26 is secured by screws, not shown, to the lower edges 27,28 of frames 4 and 5 and projects outwardly from frame 4 to support a manifold shell 29.

An aperture 30 in plate 26 provides a vacuum inlet to the manifold shell 29 for connection in use to a vacuum source.

The interior of the manifold shell 29 communicates freely with the rectangular vacuum chamber 31, defined between frames 4, 5, transverse walls 6, and plates 21 and 26, by way of slots 32 and elongate cut-outs 33 in the side frame 4.

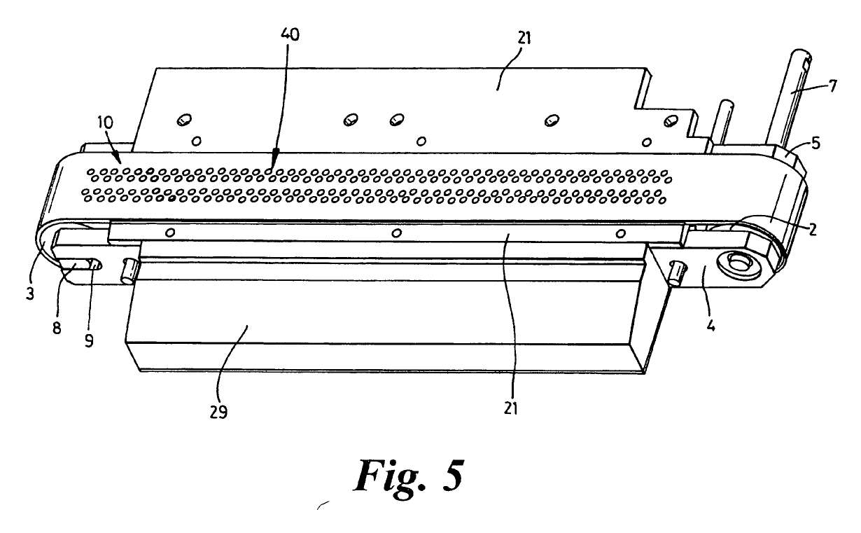

As shown in FIGS. 1 and 5, the belt 10 is pierced by a distribution of closely-spaced perforations 40, that have been punched in the base 13 of the belt.

The perforations 40 are arranged in two transversely spaced-apart bands 41. This results in an intermediate band 42 of the belt that has not been punched, and accordingly the integrity of the longitudinally-extending reinforcing strands 50, FIG. 7, in band 42 will not be affected by the creation of holes 40, thereby to retain an adequate tensile strength of the belt.

The support plate 20 is provided with two bands of perforations 45, 46 that are spaced apart by the same amount as bands 41 so that the bands 41 of the belt are respectively in register with the bands 45, 46, except that band 45 only extends for about 40% of the extent of the band 46. The reason for the short band 45 is to enhance the vacuum gripping force on coins presented to the belt at the in-feed end 25, so as to cause the coins to travel at belt speed and which may involve accelerating the coins, yet to minimise air flow losses occurring over the remainder of the upper run of the belt 10.

The use of a relatively thin support plate 20 secured to the closure plate 21, in conjunction with long and short vacuum supply slots 47, 48 in closure plate 21, helps to minimise the throttling effect of the holes 46 in the support plate assembly 20, 21, as compared with providing such holes to extend through the entire thickness of closure plate 21. The ample dimensions of slots 32 helps to maintain a full vacuum pressure in chamber 31.

The width of support plate 20 corresponds to the width of the base of the belt such that the inwardly facing faces 14′, FIG. 7, of the belt side walls 14 run along opposite longitudinal edges of the plate 20 to assist in guiding of the belt 10, the crowning of rollers 2, 3 also helping to guide the belt. Although FIG. 5 shows the coin conveying assembly in its normal position of use, it has been found possible to operate the assembly in an inverted condition.

1. A coin conveying apparatus comprising a belt provided with a perforated coin support surface, and with a rack of belt teeth, belt drive means comprising a toothed drive member meshed with the belt teeth for driving the belt, the belt being substantially devoid of coin driving projections on said coin support surface that are adapted to engage with the rear edges of coins to carry the coins with the belt, an elongate vacuum manifold extending along a portion of the path of the belt, a vacuum connection to the manifold, the arrangement being such that when a vacuum source is connected to the vacuum connection, coins that are in face contact with the coin support surface of the belt over said path portion are subject to suction forces to hold those coins against the belt, whereby the coins are conveyed by the belt along said portion of the belt path, and vacuum distribution means connected to said vacuum manifold for varying the suction forces applied to the coins according to the position of the coins along said belt path portion, whereby the suction forces are enhanced at the upstream end of the belt path portion, to assist in the initial gripping of the coins to the belt when the coins first encounter the belt.

2. Apparatus as claimed in claim 1 in which the belt in cross-section is provided with the rack of teeth along at least one lateral edge of the belt.

3. Apparatus as claimed in claim 2 in which respective racks of teeth are provided along both lateral edges of the belt, and a laterally intermediate part of the belt constitutes the coin support surface provided with the perforations.

4. Apparatus as claimed in claim 2 in which the cross-section of the belt is of shallow channel section comprising a base and side walls, said teeth being formed on at least one of said side walls of the channel section, said base of the channel section providing said support surface.

5. Apparatus as claimed in claim 4 in which said base is coated with a low-friction coating.

6. Apparatus as claimed in claim 4 comprising first and second spaced-apart conveyer rollers at upstream and downstream ends of said belt path, a belt supporting table that extends from closely adjacent to said first conveyor roller at the upstream end of the belt path to said second conveyor roller at the downstream end of the belt path.

7. Apparatus as claimed in claim 6 in which the belt supporting table carries a support plate received substantially in the channel of the belt so as to assist in guiding the belt.

8. Apparatus as claimed in claim 6 in which said supporting table forms the outer face of said vacuum manifold, the table being formed with at least one elongate slot for subjecting a lengthwise strip of the perforations of the overlying belt to vacuum.

9. Apparatus as claimed in claim 6 in which the supporting table is formed with two longitudinally-extending slots which constitute said vacuum distribution means, a first of said slots extending for substantially the full length of said plate, and a second of said slots extending from the upstream end of said plate for a limited distance from said upstream end towards the downstream end of the plate.
